(19) United States
(12) Patent Application Publication
(10) Pub. No.: US 2025/0365168 A1
(43) Pub. Date: Nov. 27, 2025

(54) SYSTEM AND METHOD FOR STORING INPUT DATA AND/OR OUTPUT DATA OF A QUANTUM COMPUTER IN A BLOCKCHAIN

(71) Applicant: Ryan G. Goudjil, Ashburn, VA (US)

(72) Inventor: Ryan G. Goudjil, Ashburn, VA (US)

(21) Appl. No.: 18/670,612

(22) Filed: May 21, 2024

(51) Int. Cl. H04L 9/00; G06N 10/80

(52) U.S. Cl. CPC H04L 9/50; G06N 10/80

(57) ABSTRACT

A system for storing a quantum computer input data or a quantum computer output data, or both in a blockchain. The system includes a network of a plurality of nodes, each node in the plurality of nodes being configured to store a copy of a plurality of blockchains, a first blockchain having a first plurality of blocks and a second blockchain having a second plurality of blocks, a block in the first plurality of blocks includes a quantum computer input data; and a quantum computer in communication with the network of nodes, the quantum computer being configured to receive or retrieve the quantum computer input data from the network of the plurality of nodes and to output the quantum computer output data to the network of nodes and to store the quantum computer output data in a block of the second blockchain within the network of nodes.

### FIELD

Embodiments of the present invention pertains to quantum computing in general, and more specifically, to a system and a method for storing input data and/or storing output data of a quantum computer in a blockchain.

### BACKGROUND

Quantum programming is the process of assembling sequences of instructions that are capable of running on a quantum computer. A quantum computer program is a series of quantum circuits, using gates, switches, and operators to manipulate a quantum system for a desired output or result of a given experiment. Quantum circuit algorithms can be implemented on integrated circuits, conducted with instrumentation, or written in a programming language for use with a quantum computer having a quantum processor. The quantum computer program instructions are generally input through a classical computer that is in communication with the quantum computer. After executing the quantum computer program instructions, the quantum computer outputs a result of the quantum computation through the classical computer.

Quantum computers are generally secure due to the property of quantum mechanics that states that performing a measurement on a quantum system with a wavefunction in a superposition of states collapses the wavefunction to one defined state. If a hacker or eavesdropper attempts to read or measure the state of the quantum system, the wavefunction of the quantum system collapses to a specific state implying that the hacker cannot tamper with the quantum system without leaving behind a telltale sign of the attempt to eavesdrop.

### SUMMARY

An aspect of the present invention is to provide a system for securing input data to a quantum computer or securing output data from the quantum computer, or both. The system includes a quantum computer; a classical computer in communication with the quantum computer, the classical computer being programmed to generate input data and transmit the input data to the quantum computer, or to receive output data by the quantum computer, or both; and a plurality of nodes in communication with each other through the internet, the plurality of nodes being configured to implement a blockchain. The input data or the output data, or both, are added as one or more blocks to the blockchain for secure storage of the input data prior to inputting into the quantum computer, or for secure storage of the output data after outputting by the quantum computer, or the input data or the output data, or both, are securely stored in a storage device and an address associated with a location in the storage device where the input data or the output data, or both are stored is added as one or more blocks to the blockchain.

Another aspect of the present invention is to provide a system for storing a quantum computer input data or a quantum computer output data, or both in a blockchain. The system includes a network of a plurality of nodes, each node in the plurality of nodes being configured to store a copy of a plurality of blockchains, a first blockchain in the plurality of blockchains having a first plurality of blocks and a second blockchain in the plurality of blockchains having a second plurality of blocks, a block in the first plurality of blocks includes a quantum computer input data; and a quantum computer in communication with the network of the plurality of nodes, the quantum computer being configured to receive or retrieve the quantum computer input data contained in the block of the first plurality of blocks of the first blockchain from the network of the plurality of nodes and to output the quantum computer output data to the network of the plurality of nodes and to store the quantum computer output data in a block of the second plurality of blocks of the second blockchain within the network of the plurality of nodes.

A further aspect of the present invention is to provide a method of extracting or retrieving by a quantum computer input data from a blockchain. The method includes receiving, by the quantum computer, an instruction from an instructing classical computer to retrieve input data stored in a block of a blockchain using a unique identifier of the block; connecting, the quantum computer, to a node in a plurality of nodes having a copy of the blockchain; searching, by the quantum computer, the node for the block in the blockchain using the unique identifier; sending, by the quantum computer, a request to the node to request the block containing the input data; and extracting, by the quantum computer, the input data from the block containing the input data.

Another aspect of the present invention is also to provide a computer readable medium on which is stored non-transitory computer-executable code, which when executed by a quantum computer causes the quantum computer to perform the above method of extracting or retrieving by a quantum computer input data from a blockchain.

### BRIEF DESCRIPTION OF THE DRAWINGS

The present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIG. 1 is a schematic diagram of a system for storing input data of a quantum computer and/or for storing output data of the quantum computer, according to an embodiment of the present invention.

FIG. 2 is a schematic diagram of a blockchain stored within a network of a plurality of nodes in communication with the quantum computer, according to an embodiment of the present invention.

FIG. 3 is a schematic diagram of a first classical computer interacting via a web-based API to generate a zero-knowledge proof (ZKP) smart contract to create input data and storing the input data in a blockchain, according to an embodiment of the present invention.

FIG. 4 is a schematic diagram of the quantum computer interacting via a web-based API to generate a zero-knowledge proof (ZKP) smart contract to store output data in a blockchain, according to an embodiment of the present invention.

FIG. 5 is a flowchart of a method of extracting by the quantum computer input data from the blockchain, according to an embodiment of the present invention.

FIG. 6 is a diagram of a general computer system used to interact with the quantum computer, according to an embodiment of the present invention.

### DETAILED DESCRIPTION

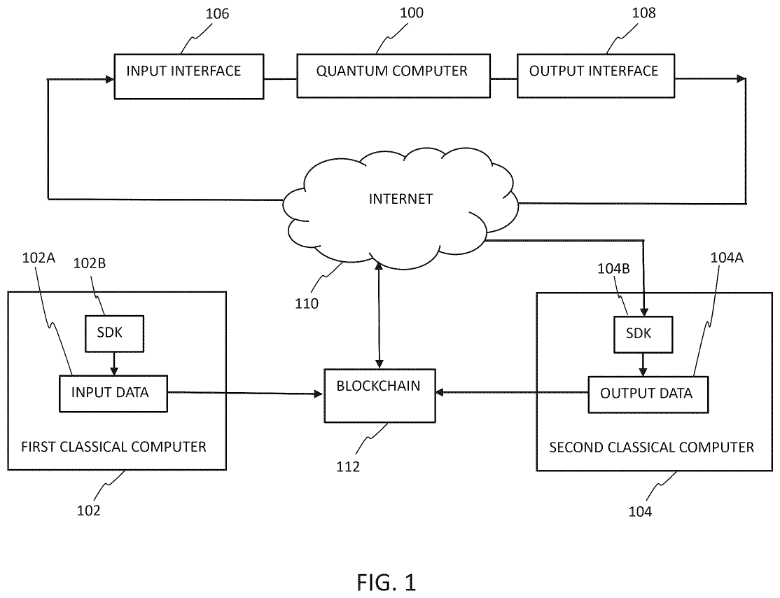

FIG. 1 is a schematic diagram of a system for storing input data of a quantum computer and/or storing output data of the quantum computer, according to an embodiment of the present invention. FIG. 1 shows a quantum computer 100 in communication with a first classical computer 102 and second classical computer 104. As shown in FIG. 1, the first classical computer 102 and the second classical computer 104 can communicate with the quantum computer 100 via the internet 110. However, the first classical computer 102 and/or the second classical computer 104 can also be directly connected to the quantum computer 100 via a wired communication line. The quantum computer 100 receives an input data 102A from the first classical computer 102 and outputs an output data 104A (e.g., data result of a computation by the quantum computer 100) to the second classical computer 104.

In an embodiment, the second classical computer 104 can be one and the same as the first classical computer 102. In this case, the first classical computer 102 inputs the input data 102A to the quantum computer 100 and also receives the output data 104A from the quantum computer 100. In another embodiment, the second classical computer 104 can be distinct from the first classical computer 102. In this case, the first classical computer 102 inputs the input data 102A to the quantum computer 100 and the second classical computer 104 receives the output data 104A from the quantum computer 100. For example, the first classical computer 102 can be associated with a first user while the second classical computer 104 can be associated with a second user. However, the first classical computer 102 and the second classical computer 104 can also be associated with the same user. In an embodiment, the second classical computer 104 can be in communication with the first classical computer 102, for example through the internet 110. The first classical computer 102 and the second classical computer 104 can be a personal computer such as a desktop computer or a laptop computer, a supercomputer, a server computer, a tablet, or any other handheld device including a smartphone, etc.

In an embodiment, the input data 102A can be a computer program generated using a Software Development Kit (SDK) 102B. The SDK 102B is typically a set of software development tools that allows the creation of applications for a software package, software platform, hardware platform, computer system, video game console, operating system, or other software development platform. In addition to the SDK 102B, an Application Programming Interface (API) can also be used. The API is an application that allows two applications to communicate with each other. Data is communicated between applications using an API. For example, the API may be provided within the SDK 102B as a module within the SDK 102B or as an application that is separate from the SDK 102B.

In another embodiment, the input data 102A can be data that is not a quantum computer program. For example, the input data 102A can be a set of input parameters for a quantum computer program. For example, the input parameters can be a code of a portion of a deoxyribonucleic acid (DNA) molecule, a portion of ribonucleic acid (RNA), or a protein, etc. In this case, the input data 102A (e.g., input parameters) may be generated using the SDK 102B in the first classical computer 102 to be transmitted to the quantum computer 100 or may also be transmitted to the quantum computer 100 without having to be generated or processed using the SDK 102B.

In an embodiment, the output data 104A can be data resulting from a quantum computation implemented by the quantum computer 100. The output data 104A may or may not need to be processed using an SDK 104B. The SDK 104B is typically a set of software development tools that allows the creation or processing of applications or data for a software package, software platform, hardware platform, computer system, video game console, operating system, or other software development platform. An API may also be provided within the SDK 104B as a module within the SDK 104B or as an application that is separate from the SDK 104B.

In an embodiment, the SDK 102B and/or the SDK 104B can include a QISKIT library of programs by International Business Machines (IBM) Corporation written, for example, in PYTHON language by PYTHON Software Foundation, SWIFT language by Apple Inc. or JAVA language by Oracle America, Inc. QISKIT is an open-source framework for quantum computing developed by IBM. QISKIT provides tools for creating and manipulating quantum computer programs and running the quantum computer programs on quantum computers.

In an embodiment, an Application Program Interface (API) can be used to communicate between different applications generated by the SDK (e.g., QISKIT) to interact with the first classical computer 102 to generate the input data 102A (e.g., quantum computer program), to manipulate or change the quantum computer program and transmit the quantum computer program to be executed by the quantum computer 100. The API can be used together with QISKIT or provided as part of QISKIT. Examples of such APIs, include QISKIT.CIRCUIT, QISKIT Finance API, QISKIT runtime API, etc.

Although QISKIT is used herein as an example of a SDK tool to create quantum computer programs, tools for creating quantum computer programs are not limited to QISKIT as other SDKs exist including: a) FOREST from RIGETTI, Inc. and its PYTHON-based PYQUIL library, b) PERCEVAL an open-source project created by QUANDELA for designing photonic quantum circuits and developing quantum algorithms, based on PYTHON, c) OCEAN an Open Source suite of tools developed by D-Wave and written mostly in the Python programming language to formulate problems in Ising Model and Quadratic Unconstrained Binary Optimization formats (QUBO), d) PROJECTQ an Open Source project developed at the Institute for Theoretical Physics at ETH using the Python programming language to create and manipulate quantum circuits, c) QIBO an open source full-stack API for quantum simulation, quantum hardware control and calibration developed by multiple research laboratories, including Quantum Research Center QRC and The National Institute for Nuclear Physics INFN, f) T|KET> a quantum programming environment and optimizing compiler developed by Cambridge Quantum Computing that targets simulators and several quantum hardware back-ends, g) STRAWBERRY FIELDS an open-source Python library developed by Xanadu Quantum Technologies for designing, simulating, and optimizing continuous variable (CV) quantum optical circuits, h) PENNYLANE an open-source PYTHON library developed by XANADU QUANTUM TECHNOLOGIES for differentiable programming of quantum computers to create models using TensorFlow, NumPy, or PyTorch, and connect the models with quantum computer backends available from IBMQ, GOOGLE QUANTUM, RIGETTI, QUANTINUUM and ALPINE QUANTUM TECHNOLOGIES, i) QUANTUM DEVELOPMENT KIT developed by Microsoft as part of the .NET Framework allowing to write and run quantum programs within Visual Studio and VSCode using the quantum programming language Q# for running on MICROSOFT AZURE QUANTUM, and other quantum computers from QUANTINUUM, IONQ, and PASQAL, j) CIRQ an open Source project developed by GOOGLE using Python programming language to create and manipulate quantum circuits for running on IONQ, PASQAL, RIGETTI, and ALPINE QUANTUM TECHNOLOGIES, or k) other SDKs that may be developed in the future that enable the development of quantum computer programs.

In an embodiment, the SDK (e.g., QISKIT) may be installed on the first classical computer 102 for implementing the quantum computer program in a PYTHON language environment, for example. In an embodiment, the first classical computer 102 can be a personal computer of a user, or a server computer. In another embodiment, the first classical computer 102 can also be implemented as a “cloud” computing service in which case the SDK 102B (e.g., QISKIT) is implemented or housed on one or more servers on the internet 110 remote from the first classical computer 102 and the user.

The input data 102A (e.g., the quantum computer program) implemented using the SDK 102B (e.g., QISKIT) may include one or more command lines to be executed by the quantum computer 100. For example, the command lines can include instructions to read or output data, or both. The one or more command lines may also include calls to other existing quantum computer programs or codes (for example, codes from libraries of existing codes, etc.).

In an embodiment, the input data 102A (e.g., quantum computer program) may be stored in a computer program product which include a computer readable medium or storage medium or media. Examples of suitable storage medium or media include any type of disk including floppy disks, optical disks, DVDs, CD ROMs, magnetic optical disks, RAMS, EPROMS, EEPROMs, magnetic or optical cards, hard disk, flash card (e.g., a USB flash card), PCMCIA memory card, smart card, or other media. In another embodiment, the quantum computer program can be downloaded from another remote classical computer or server via a network such as the internet 110, an ATM network, a wide area network (WAN) or a local area network. In yet another embodiment, the input data 102A (e.g., the quantum computer program) can be stored in the cloud on a server platform or a Network Attached Storage (NAS) connected to the internet 110, for example. In some embodiments, the input data 102A (e.g., the quantum computer program) can be implemented as program products in the first classical computer 102 (e.g., a personal computer, a server computer or in a distributed computing environment). For example, the first classical computer 102 interacts with the quantum computer 100 by sending instructions to the quantum computer 100, for example via the internet 110. The quantum computer 100 in turn sends the output data 104A (e.g., the result of the quantum computation) to the second classical computer 104 (e.g., a personal computer or a server computer in a distributed computing environment).

The first classical computer 102 provides input data 102A (e.g., the quantum computer program instructions or parameters) to the quantum computer 100. The second classical computer 104 receives output data 104A (e.g., data results or parameters) from the quantum computer 100. The input data 102A may include instructions from a quantum computer program (for example, setting up qubits, gates, etc.) and performing various operations using operators (e.g., Hadamard operator, Unitary operator, Controlled-NOT operator, Swap operator, etc.). The output data 104A may include quantum data results of a computation of the quantum computer program executed by the quantum computer 100 (e.g., a measurement of the quantum state).

In an embodiment, the first classical computer 102 interfaces with the quantum computer 100 via a quantum computer input interface 106. The second classical computer 104 interfaces with the quantum computer 100 via a quantum computer output interface 108. The quantum computer input interface 106 and the quantum computer output interface 108 are directly connected to the quantum computer 100 via a wired line or an optical line. For example, the quantum computer input interface 106 enables controlling the qubits and quantum circuits within the quantum computer 100. The quantum computer input interface 106 may include Digital-to-Analog Converters (DACs) to convert digital data from the first classical computer 102 into analog signals to be input into the quantum computer 100. For example, the quantum computer output interface 108 allows performing a readout of outputs from the quantum computer 100. The quantum computer output interface 108 may include Analog-to-Digital Converters (ADCs) to convert analog signal from the quantum computer 100 into digital data to be read by the second classical computer 104. The first classical computer 102 sends commands or instructions included within the input data 102A (e.g., the computer program) to be executed by the quantum computer 100 via the quantum computer input interface 106. The second classical computer 104 receives output data 104A (e.g., results of a quantum computation of the quantum program) via the quantum computer output interface 108.

The first classical computer 102 can communicate with the quantum computer input interface 106 via a wired connection, a wireless connection, or via the internet 110. The second classical computer 104 can communicate with the quantum computer output interface 108 via a wired connection, a wireless connection, or via the internet 110. For example, the first classical computer 102 can communicate with the quantum computer input interface 106 via the internet 110. The quantum computer 100 outputs the output data 104A (e.g., results of a quantum computation of the quantum program) to the second classical computer 104 via the quantum computer output interface 108. For example, the second classical computer 104 can communicate with the quantum computer output interface 108 via the internet 110.

In an embodiment, the quantum computer input interface 106 and the quantum computer output interface 108 can also be configured to minimize environmental effects on the quantum computer 100 by isolating the quantum computer 100 from noise, temperature variation, undesirable signal couplings and other effects. The quantum computer input interface 106 and the quantum computer output interface 108 can be configured to operate as serial or as parallel communication channels. The quantum computer input interface 106 and the quantum computer output interface 108 can include semiconductor circuits, superconductor circuits, optical or photonic devices and channels, digital circuits, and/or analog circuits, etc.

The quantum computer 100 can be a superconducting quantum computer such as the IBM quantum computer, a trapped-ion quantum computer such as IONQ quantum computer, neutral atom-based quantum computer such as COLDQUANTA quantum computer, a photonic quantum computer such as XANADU or ORCA quantum computer, quantum dots-based quantum computer such as DIRAQ or SIQUANCE quantum computer, or a simulated quantum computer, etc. A simulated quantum computer is used herein to mean a classical computer that uses program instructions that simulate operations implemented on a real or physical quantum computer. For example, the superconducting quantum computer (e.g., IBM quantum computer) has one or more quantum circuits and each quantum circuit includes one or more quantum gates executed on one or more quantum processors.

For example, in the case of a superconducting quantum computer (e.g., the IBM quantum computer) or a trapped-ion quantum computer (e.g., IonQ quantum computer), the quantum computer input interface 106 includes one or more Digital-to-Analog converters (DACs) to convert digital data from the first classical computer 102 into analog signals to be input into the quantum computer 100. For example, in the case of a superconducting quantum computer, radiofrequency signals or microwave signals can be transmitted through an electrical wire or an optical fiber to superconducting processors (e.g., including one or more superconducting qubits) of the superconducting quantum computer. In the case of a trapped-ion quantum computer, lasers are used to excite trapped ions to control the states of the ions in the trapped-ion quantum computer.

In the case of a superconducting quantum computer, the quantum computer output interface 108 includes one or more Analog-to-Digital converters (ADCs) to convert analog signals (e.g., radiofrequency signals or microwave signals) corresponding to results or measurements from the quantum computer 100 into digital data to be sent to the second classical computer 104. For example, the radiofrequency signals or microwave signals from the quantum computer 100 can be transmitted through an electrical wire or an optical fiber to the quantum computer output interface 108, in the case of the superconducting quantum computer. In the case of the trapped-ion quantum computer, the photons emitted by the trapped ions can be transmitted to the quantum computer output interface 108 (including one or more ADCs) to be converted to digital electrical data.

For example, in a superconducting computer, the quantum processors are provided within a cryogenic vessel to maintain the quantum processor within cryogenic temperatures to minimize external interference. Josephson junctions are used as basic building elements within the quantum processors, and radiofrequency (RF) signals are used to manipulate the energy levels of the Josephson junctions to generate the qubit states. In a trapped-ion quantum computer, ions are trapped and isolated using electromagnetic fields. The energy levels of the trapped ions serve as the qubit states and laser beams are used to manipulate the qubit states.

The quantum computer program has a series of quantum circuits, using gates, switches, and operators to manipulate a quantum system for a desired outcome or results of a given experiment. Quantum circuit algorithms can be implemented on integrated circuits, conducted with instrumentation, or written in using a SDK such as QISKIT in a programming language such as PYTHON for use with a quantum computer or a quantum processors.

An example of QISKIT computer program is provided below for illustration.

from giskit import QuantumCircuit, QuantumRegister, ClassicalRegister, execute, BasicAer
from giskit.visualization import plot_ histogram
from pylatexenc import *
qc_one = QuantumCircuit (4,2)
qc_one.cx(0, 2)
qc_one.cx(1, 2)
qc_one.ccx (0, 1, 3)
qc_one.barrier ( )
qc_one.measure (2, 0)
qc_one.measure (3, 1)
qc_one.draw( )

The quantum computer 100 is generally secure due to the property of quantum mechanics that states that performing a measurement on a quantum system with a wavefunction in a superposition of states collapses the wavefunction to one defined state which can then enable detection of the measurement. The collapse of the wavefunction into the defined state provides a signature that a state of the quantum system is measured and thus allows detecting that a measurement is performed on the quantum system. If a hacker or eavesdropper attempts to read or measure the state of the quantum system within the quantum computer 100, the wavefunction of the quantum system collapses to a specific state implying that a hacker cannot tamper with the quantum system without leaving behind a telltale sign of the attempt to eavesdrop activity. Hence, the input data 102A (e.g., the quantum computer program) is secure within the quantum computer 100. However, the input data 102A (e.g., the quantum computer program) may not be secure when residing in the first classical computer 102. In addition, the output data 104A (e.g., results of the execution of the quantum computer program) may be secure while inside the quantum computer 100. However, once the output data 104A (e.g., results of the quantum computation) is received by the second classical computer 104, the output data 104A may no longer be secure and may be subject to hacking or eavesdropping. An extensive primer on security of quantum computing can be found in “A Primer on security of Quantum Computing” by Ghosh et al., arXiv:2305.02505 (May 4, 2023), the entire content of which is incorporated herein by reference.

Therefore, a method or system to securely store the input data 102A prior to inputting to the quantum computer 100 and/or to securely store the output data 104A after outputting by the quantum computer 100 is desirable in order to ensure that the input data 102A (e.g., the quantum computer program written with the SDK in the first classical computer 102) input to the quantum computer 100 and/or the output data 104A (e.g., the data results of the quantum computation) output by the quantum computer 100 to the second classical computer 104 remain also secured and protected from hacking or prying eyes.

As shown in FIG. 1, the system for storing input data 102A of the quantum computer 100 and/or storing output data 104A of the quantum computer 100 includes a blockchain 112 that is used to store the input data 102A (e.g., the quantum computer program) prior to transmitting to the quantum computer 100 and/or to store the output data 104A from the quantum computer 100. Although the blockchain 112 is depicted in FIG. 1 as being separate from and in communication with the internet 110, the blockchain 112 can also be provided as part of the internet 110 as whole or connected to the internet 110 (e.g., in a cloud environment). The blockchain 112 will be described in more detail in the following paragraphs. In addition, although the output data 104A is shown in FIG. 1 being received by the second classical computer 104 and then transmitted and inserted or stored in the blockchain 112, the output data 104A can also be transmitted directly and inserted or stored directly by the quantum computer 100 in the blockchain 112 without passing through the second classical computer 104, as will be further described in the following paragraphs.

The input data (quantum input data) 102A is different from classical computer input data in many ways. One way is that quantum input data is input to a quantum computer. In quantum computing, input data 102A can control states within the quantum computer 100 to be in a superposition of states, allowing for simultaneous processing of multiple inputs. Quantum bits, or qubits, can represent both 0 and 1 simultaneously until measured, enabling parallel computations and potentially exponential speedups for certain algorithms. Classical computers such as first classical computer 102, on the other hand, process data using classical bits, which can only represent one of two states at any given time (either 0 or 1). Hence, while a standard n-bit register in a classical computer can only represent one of the 2ⁿ basis states, an n-qubit system in a quantum computer can represent all 2ⁿ basis states concurrently. Input data in classical computing is typically processed sequentially, one state at a time. Quantum input data can harness the principles of superposition and entanglement to perform computations differently from classical input data, potentially leading to significant computational advantages for certain tasks or applications.

The output data 104A from the quantum computer 100 depends on the specific algorithm or problem being solved. In general, after running a quantum program, the output data 104A is obtained by measuring the quantum state of the qubits in the quantum computer 100. In quantum algorithms, the output data 104A can be a solution to a specific problem or the result of a quantum computation. For example, in Shor's algorithm, the output data 104A is the prime factors of a large number. In quantum simulations, the output data 104A can be, for example, the simulated behavior of a quantum system, such as the ground state energy or the excited state energy of a molecule, or the properties of a material (e.g. dielectric properties, vibration properties, etc.). In quantum machine learning (QML), the output data 104A can represent predictions or classifications based on the input data 102A. In quantum cryptography, the output data 104A, can be encrypted or decrypted data messages. In addition, various hybrid classical-quantum computing algorithms such as the Variational Quantum Eigensolver (VQE) can be used to compute approximate solutions in presence of quantum noise. The hybrid classical-quantum computing algorithms employ a classical computer such as the first classical computer 102 to drive the quantum computer 100 iteratively to reach a solution to a given problem.

In an embodiment, the blockchain 112 includes a plurality of blocks for storing data, for example, a plurality of computer programs. Each block of the plurality of blocks in the blockchain 112 includes one or more computer programs. A blockchain is distributed which means multiple copies of the blockchain are stored on many server computers or nodes and the copies must all match for the blockchain to be valid. The blockchain collects transaction information and enters the transaction information into a block, similar to a cell in a spread sheet containing information. Once a block in the blockchain is full, the transaction information is run through an encryption algorithm which creates a hexadecimal number called a hash. The hash is then entered into a block header of the following block in the blockchain and encrypted with the other information in the block. This creates a series of blocks that are chained together, thus the use of the term blockchain. Each block may contain a plurality of transactions (e.g., hundreds to thousands of transactions). The blockchain is generally known to play a role in conventional cryptocurrency systems (such as BITCOIN and ETHEREUM, etc.) for maintaining a secure and decentralized record of digital money transactions. However, the blockchain can also be used in many other fields.

A blockchain allows data in a database to be spread out among a plurality of distributed network nodes at various locations. The nodes can be computers (e.g., server computers) or devices running software for the blockchain. The storage of copies of the blockchain at the plurality of nodes is used to ensure fidelity of the data in the block. For example, if someone tries to alter a record within the blockchain at one node, the other nodes would prevent such action. Hence, no single node within the network of nodes can alter information held within the node. Therefore, the fact that the blockchain or copies of the blockchain are stored within the plurality of nodes, the information and history of the blockchain, such as, for example, transactions recorded in the blockchain within cryptocurrency systems, are irreversible. The blockchain can store records of transactions or other data such as, computer programs, legal contracts, state identifications, inventories of a company, medical records, etc.

Due to the decentralized nature of the location of blockchain in the plurality of nodes, all transactions can be transparently viewed by either having a personal node or using blockchain explorers that allow anyone to see transactions occurring live, in certain applications. Each node in the plurality of nodes has its own copy of the blockchain that gets updated as fresh blocks are confirmed and added. In certain applications, the data stored in the blockchain is encrypted. Therefore, only a person with the proper credentials can have access to the information stored in the blockchain. For example, only a person having the proper credentials can have access and be able to read a specific computer program stored within a block of the blockchain.

The fact that the blockchain is decentralized as copies of the blockchain are stored in the plurality of nodes provides layers of security and trust. First, blocks are always added and stored in the blockchain linearly and chronologically. In other words, the blocks are always added to the “end” of the blockchain. After a block is added to the end of the blockchain, previous blocks cannot be changed. Second, altering any data within a block changes the hash of the block the data is stored in. Because each block contains the hash of previous block, if a change occurs in one, this would change the following blocks. As a result, upon performing verification, the network of the plurality of nodes can detect the occurrence of the change in the block within the blockchain and would reject the altered block because the hashes are altered and thus would not match the hashes stored in other copies of the blockchain stored at different nodes.

Therefore, the use of a blockchain provides many benefits. One benefit is the accuracy of the blockchain. Transactions on the blockchain are approved by the plurality of nodes (many computers or devices). This removes human interaction from the verification process, resulting in less human error and an accurate record of information. Even if a node in the plurality of nodes were to make a computational mistake, the error would only be made in one copy of the blockchain and thus upon verification by the remaining nodes in the plurality of nodes the error would be detected, and the error would not be accepted by the remaining nodes. Another benefit is to provide cost reduction in verification of transactions. The use of the blockchain eliminates the need for third-party verification, and the associated costs of verification. For example, business owners incur a small fee when they accept credit card payments because banks and payment-processing companies have to process those transactions. Bitcoin, on the other hand, does not have a central authority and has limited transaction fees. A further benefit of using a blockchain is the ability of the blockchain to provide secure transactions. Once a transaction is recorded, its authenticity is verified by the plurality of nodes. After the transaction is validated, it is added to the blockchain block. Each block on the blockchain contains its unique hash and the unique hash of the block before said block. Therefore, the blocks in the blockchain cannot be altered without the network of nodes detecting the occurrence of the alteration.

A blockchain can be created in many ecosystems or platforms including ETHEREUM (introduced the concept of smart contract and enabling developers to create decentralized applications or DApps on its blockchain), BITCOIN (primarily used as a digital currency and the blockchain in BITCOIN is used as a decentralized ledger for recording BITCOIN transactions), BINANCE SMART CHAIN (designed to be compatible with ETHEREUM), CARDANO (a blockchain platform focused on academic research and provides secure and scalable infrastructure for smart contracts), POLKADOT (a multi-chain network that enables different blockchains to interoperate and share information), SOLANA (a blockchain platform designed for decentralized applications and crypto projects with lower transaction fees), TEZOS (a blockchain platform focusing on self-governance and allows token holders to vote on proposed protocol upgrades and changes), RIPPLE (a blockchain platform for payment designed for cross-border payments between financial institutions), CHAINLINK (an ORACLE network that connects smart contracts with real-world data and events, and acts as a bridge between smart contracts and external data sources), STELLAR (a blockchain platform designed for issuance of digital assets used by financial institutions), EOS (a blockchain platform focused on scalability and provides an environment for developing apps), AVALANCE or AVAX (a blockchain platform designed for creating custom blockchains and interoperable networks), FILECOIN (a blockchain-based decentralized storage network that enables users to rent out their excess storage space and earn tokens in return). There are many projects and examples of blockchains with various purposes and features.

According to an embodiment of the present invention, in addition to the above existing blockchains, a specific blockchain platform can also be created and dedicated for a specific application. For example, in an embodiment of the present invention, a blockchain platform (Q-Chain) can be created for the storage of quantum computer input data (e.g., a quantum computer program) and/or a quantum computer output data (e.g., a result of the execution of the quantum computer program). In an embodiment, a pre-built blockchain open-source such as ETHEREUM can be used to avoid using a more complex core engine. Alternatively, a blockchain platform can be built from scratch or an existing blockchain platform modified using existing open-source code. The blockchain can be created using PYTHON, JAVASCRIPT, C++, or any other suitable computer programming language.

Following is an example a computer program or code in PYTHON computer language for creating a blockchain.

```
import hashlib
import time
class Block:
  def _{——}init_{——}(self, index, previous_hash, timestamp, data, hash):
    self.index = index
    self.previous_hash = previous_hash
    self.timestamp = timestamp
    self.data = data
    self.hash = hash
def calculate_hash(index, previous_hash, timestamp, data):
  value = str(index) + str(previous_hash) + str(timestamp) + str(data)
  return hashlib.sha256(value.encode( )).hexdigest( )
def create_genesis_block( ):
  return Block(0, “0”, int(time.time( )), “Genesis Block”, calculate_hash(0, “0”, int(time.time( )), “Genesis
Block”))
def create_new_block(previous_block, data):
  index = previous_block.index + 1
  timestamp = int(time.time( ))
  hash = calculate_hash(index, previous_block.hash, timestamp, data)
  return Block(index, previous_block.hash, timestamp, data, hash)
# Create the blockchain and add the genesis block
blockchain = [create_genesis_block( )]
previous_block = blockchain[0]
# Add blocks to the blockchain
num_blocks_to_add = 5
for _ in range(num_blocks_to_add):
  data = f“Block {previous_block.index + 1}”
  new_block = create_new_block(previous_block, data)
  blockchain.append(new_block)
  previous_block = new_block
  print(f“Block #{new_block.index} has been added to the blockchain!”)
  print(f“Hash: {new_block.hash}\n”)
# Print the entire blockchain
for block in blockchain:
  print(f“Block #{block.index}”)
  print(f“Timestamp: {block.timestamp}”)
  print(f“Data: {block.data}”)
  print(f“Hash: {block.hash}”)
  print(f“Previous Hash: {block.previous_hash}\n”)
```

A specific quantum blockchain platform (Q-Chain) can be created for the storage of quantum computer input data (e.g., a quantum computer program) and/or a quantum computer output data (e.g., a result of the execution of the quantum computer program) for multiple reasons. One reason is the ability to customize the blockchain to tailor the features of the blockchain to the specific storage of quantum computer input data and/or quantum computer output data. The features can include, for example, consensus mechanisms, governance models, and smart contract functionality, as will be described in detail in the following paragraphs. Another reason for creating a specific blockchain platform (Q-Chain) for the storage of quantum computer input data and/or quantum output data is to provide more independence to operate without relying on existing blockchain networks, thus providing autonomy in managing transaction and data and/or controlling transaction fees, etc. Furthermore, building a blockchain ab initio can provide control over security measures, ensuring that the network of nodes aligns with the standard for trust and integrity set by the creator of the custom blockchain. In addition, launching a new quantum blockchain can foster a community of quantum computing users and quantum data developers in contributing to the network's growth and sustainability. Finally, creating a quantum blockchain for the storage of quantum computer input data or quantum computer output data may offer opportunities for revenue generation through token sales, transaction fees, or other monetization strategies for a target audience (e.g., the quantum computing audience).

A block in the blockchain may contain one or more smart contracts. The one or more smart contracts are stored within one or more blocks in the blockchain. A smart contract is a self-executing contract or computer program with the terms of an agreement directly written into the computer program. A smart contract (e.g., a computer program) stored in a blockchain created using a specific blockchain platform can use zero-knowledge proofs. A zero-knowledge proof is a method by which one party (the prover) can prove to another party (the verifier) that a given statement is true, while avoiding conveying to the verifier any information beyond the mere fact of the truth of the statement. This means that, for example, the computer program stored in a block of the blockchain is not inherently accessible on the blockchain which secures the blockchain from external tampering. Hence, a user may be able to see if the computer program exists within a block of the blockchain. However, the user is not be able to see or read the computer program itself. Smart contracts can be written using many blockchain specific programming languages. For example, ETHEREUM primarily uses SOLIDITY while other blockchain platforms may use other languages.

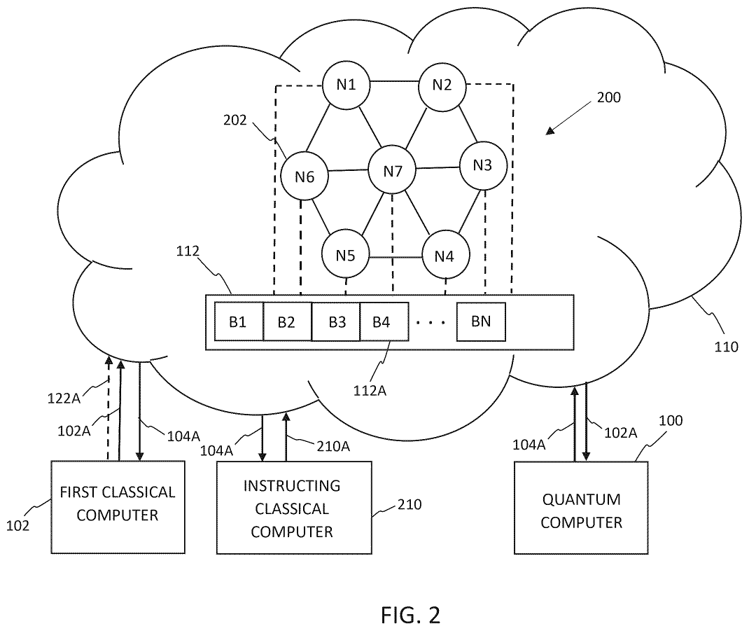

FIG. 2 is a schematic diagram of a blockchain stored within a network of a plurality of nodes in communication with the quantum computer, according to an embodiment of the present invention. The blockchain 112 has a plurality of blocks B1, B2, B3, B4, . . . , BN (where N is an integer number). Although the blockchain 112 is shown in FIG. 2 as having the plurality of blocks B1, B2, B3, B4, . . . , BN, the blockchain 112 can have one, two, or more blocks 112A. The blockchain 112 is distributed. Multiple copies of the blockchain 112 are stored on a plurality of nodes 200 (N1, N2, N3, N4, N5, N6, N7 . . . ) and the copies of the blockchain 112 must all match for the blockchain 112 to be valid. Each node 202 in the plurality of nodes 200 (N1, N2, N3, N4, N5, N6, N7 . . . ) can correspond to a computer or device that communicates through the internet 110 or a server that resides in the cloud. The term “resides in the cloud” means that each node is a remote computer server at a physical location that is connected to the internet 110. Although seven nodes (N1, N2, N3, N4, N5, N6, N7) are depicted in FIG. 2, any number of nodes can be used, for example, two, three or more distributed nodes can be used. In general, there may be hundreds to thousands of distributed nodes depending on the type of blockchain used. Although the plurality of nodes 200 (N1, N2, N3, N4, N5, N6, N7 . . . ) are shown in FIG. 2 inside a cloud representing the internet 110, it is understood that the plurality of nodes 200 (N1, N2, N3, N4, N5, N6, N7 . . . ) are connected to the internet 110 and can be distributed at various physical locations (e.g., geographical locations).

In an embodiment, the input data 102A (e.g., the quantum computer program) generated by the first classical computer 102 is added to the block 112A of the blockchain 112. In another embodiment, instead of or in addition to adding the input data 102A to the block 112A of the blockchain 112, an address 122A where the input data 102A is stored is added to the block 112A of the blockchain 112. The quantum computer 100 is provided instructions to retrieve the input data 102A (e.g., the quantum computer program) stored within the block 112A (e.g., block B4) in the blockchain 112 and process the input data 102A (e.g., execute the quantum computer program).

In an embodiment, instructions 210A to retrieve the input data 102A stored within a block 112A of the blockchain can be sent separately to the quantum computer 100 by instructing classical computer 210. In an embodiment, the instructing classical computer 210 can be the same as the first classical computer 102 that generated or created the input data 102A. In another embodiment, the instructing classical computer 210 can be a classical computer separate from the first classical computer 102 that generated or created the input data 102A.

First, based on the instructions from the instructing classical computer 210, the quantum computer 100 is instructed to fetch or retrieve the input data 102A from the block 112A using a unique identifier of the block 112A. Each block 112A in the blockchain 112 has a unique identifier, typically called the “block hash” or “block number.” The quantum computer 100 is provided the hash of the block 112A (e.g., block B4) or the position of the block 112A (e.g., block B4) in the blockchain 112. The quantum computer 100 is instructed to connect to the blockchain, that is to connect to one of the plurality of nodes 200 having a copy of the blockchain 112, either by running or searching fully the node 202 in the plurality of nodes 200 or through a third-party service or API that provides blockchain data.

The quantum computer 100 then sends a request to the blockchain network, i.e., the network of plurality of nodes 200, to request for the specific block 112A containing the input data 102A (e.g., the quantum computer program). The request is typically sent to one of the nodes 202 (e.g., node N6) in the network of the plurality of nodes 200. The quantum computer 100 receives the block 112A from the network of the plurality of nodes 200, and the quantum computer 100 is instructed by the instructing classical computer 210 to verify the authenticity of the block 112A. The quantum computer 100, following the instructions from the instructing classical computer 210 checks the cryptographic hash of the block 112A to ensure the cryptographic hash matches the expected value, confirming that the block 112A is not altered.

After verification, the quantum computer 100 is instructed by the instructing classical computer 210 to extract the input data 102A from the block 112A containing the input data 102A. The input data 102A is organized in a structured format depending on the blockchain 112. For example, in ETHEREUM, a block 112A also contains a list of transactions and other metadata as well as the input data 102A. The quantum computer 100 then reads the input data 102A, interprets the input data 102A according to a protocol of the blockchain and the specific format used to store the input data 102A in the blockchain 112, and then executes the input data 102A if the input data 102A is a quantum computer program.

In an embodiment, the quantum computer 100 may send a message to the classical computer 210 informing the instructing classical computer 210 that the quantum computer 100 was able to retrieve and read the input data 102A. The quantum computer 100 may also send a message to the instructing classical computer 210 indicating the input data 102A (e.g., the quantum computer program) is executed and may send back the output data 104A to the instructing classical computer 210, to the first classical computer 102, and/or to the second classical computer 104 (shown in FIG. 1). For example, the quantum computer 100 may send a copy of the output data 104A to the first classical computer 102 and to the second classical computer 104.

In another embodiment, instead of, or in addition to sending the output data 104A (e.g., result of the quantum computation) to the instructing classical computer 210, the first classical computer 102, and/or the second classical computer 104, the output data 104A can be added to a block in the blockchain 112. The quantum computer 100 determines which block in the blockchain 112 the output data 104A is to be added based on instructions from the instructing classical computer 210. For example, the block where the output data 104A may be added can be block BN in the blockchain 112 or a block of a blockchain different from blockchain 112. In an embodiment, the output data 104A can refer to the input data 102A that created the output data 104A. For example, the block BN containing the output data 104A can refer to the block B4 containing the input data 102A that created the output data 104A.

In an embodiment, the output data 104A can be added to a blockchain, for example, but not limited to, to the blockchain 112 containing the block B4 containing the input data 102A. However, the output data 104A can also be added to another block (e.g., block BN) or even a different blockchain that does not include the block containing the input data 102A. In any case, adding the output data 104A to a block in a blockchain involves creating a new transaction or record that contains the output data 104A.

In an embodiment, each node (N1, . . . , N7) in the plurality of nodes 200 can store a copy of a plurality of blockchains (including blockchain 112). The plurality of blockchains (including blockchain 112) can be stored in nodes such as cloud-based storage devices or local premises storage systems, or both. For example, a first blockchain (e.g., blockchain 112) in the plurality of blockchains can have a first plurality of blocks (e.g., B1, B2, . . . ), and a second blockchain in the plurality of blockchains can have a second plurality of blocks. A block in the first plurality of blocks (e.g., B1, B2, . . . ) can include the quantum computer input data 102A. The quantum computer 100 can be configured to receive or retrieve the input data 102A contained in the block of the first blockchain (e.g., blockchain 112) from the network of the plurality of nodes 200 and to output the output data 104A to the network of the plurality of nodes 200 and to store the output data 104A in a block of the second plurality of blocks within the network of the plurality of nodes 200. For example, the first blockchain (e.g., the blockchain 112) and the second blockchain (not shown) can be the same blockchain. In this case, the input data 102A and the quantum computer output data are stored within the same blockchain.

The process of adding the output data 104A to a blockchain can vary depending on the blockchain platform and whether the user is working with a public blockchain such as ETHEREUM, BITCOIN, or a private blockchain such as a blockchain dedicated to quantum computing (e.g., Q-Chain). The Q-Chain is a blockchain dedicated to quantum computing that is created by the present inventor for the specific use in quantum computing.

First, the user determines which blockchain platform to use for the output data 104A. Popular platforms include ETHEREUM, and others, or the user can also create a custom blockchain. If the user is using cryptocurrency-based blockchain platforms such as ETHEREUM, for example, the user first creates a digital wallet to send transactions. The wallet is provided with a private key for signing transactions. After creating the digital wallet or a previously logging into a previously created digital wallet, the user creates or initiates a transaction. For example, if the user intends to add the output data 104A into a block (e.g., block BN in blockchain 112) in ETHEREUM, the user can create a transaction with a “data” field. This field can contain arbitrary data or be used to interact with a smart contract. The user then uses the user's wallet's private key to sign the transaction. This cryptographic signature proves that the user has the authority to create this transaction. Next, the transaction is broadcast by sending the signed transaction to the blockchain network. Depending on the platform, the user can use various tools, libraries, or services to broadcast the transaction.

Validators can then confirm the transaction. In a Proof of Work (PoW) blockchain, the validators or “miners” include the transaction in a block that the validators are verifying. In a Proof of Stake (PoS) or other consensus algorithms, validators which can be nodes (e.g., N1, N2, . . . ) within the network of plurality of nodes 200 can confirm and add the transaction to a block (e.g., block B1 within blockchain 112).

The user waits for confirmation that the output data 104A is added to a block (e.g., block BN in blockchain 112). It may take some time for the transaction to be confirmed and stored or inserted in a block. Once the transaction is confirmed, the user can retrieve the block that contains the output data 104A using the blockchain's API or a block explorer. The block explorer is a web tool that allows a user to search and view data on the blockchain 112. Depending on a use case, the user can extract and interpret the output data 104A from the block BN of the blockchain 112, as desired.

In public blockchain platforms such as ETHEREUM, adding the input data 102A and/or the output data 104A to a blockchain often involve transaction fees. The transaction fees must be paid by the user to incentivize validators (e.g., miners or nodes) to include the transaction in a block. Private or consortium blockchains may have different mechanisms and may or may not require fees.

As it must be appreciated the above process steps can be implemented automatically by a classical computer such as the requesting classical computer 210, after receiving the output data 104A from the quantum computer 100 via the internet 110. The above process steps can also be implemented by dedicated servers in the cloud connected to the internet 110.

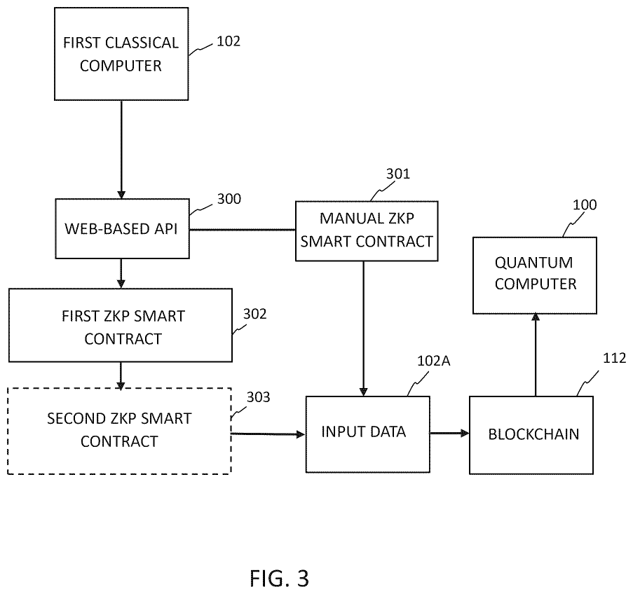

FIG. 3 is a schematic diagram of the first classical computer 102 interacting via a web-based API to generate a zero-knowledge proof (ZKP) smart contract to create input data 102A and storing the input data 102A in a blockchain 112, according to an embodiment of the present invention. A zero-knowledge proof (ZKP) smart contract is a type of smart contract that leverages zero-knowledge proofs to validate and execute transactions or computations without revealing the underlying sensitive data to the network. Zero-knowledge proofs are cryptographic techniques that allow one party (the prover) to prove to another party (the verifier) that they possess certain knowledge, such as a secret key or some specific data, without revealing that knowledge. In the context of smart contracts, zero-knowledge proofs can provide several benefits. A first benefit is privacy as zero-knowledge proofs enable transactions to be executed on a blockchain without revealing the specific details of those transactions. This enhances privacy for participants by keeping sensitive information confidential. A second benefit is efficiency by allowing computations to be performed off-chain (privately). Zero-knowledge proofs can improve the efficiency and scalability of blockchain networks. Complex computations can be processed without burdening the blockchain itself. A third benefit is security as zero-knowledge proofs can enhance security by enabling trustless verification of transactions or conditions. This means that parties can trust the outcome of a smart contract without revealing all the details to each other. A fourth benefit is regulatory compliance as zero-knowledge proof smart contracts can help organizations comply with data protection regulations, as sensitive data remains private while still being verifiable.

In an embodiment, instead of directly creating and then storing by the first classical computer 102 the input data 102A in the block 112A of the blockchain 112, a web-based application programming interface (API) 300 can be used by a user to generate a zero-knowledge proof (ZKP) smart contract 301 that would then run to generate and then store the input data 102A in a block 112A of the blockchain 112. The zero-knowledge proof (ZKP) smart contract 301 can be created manually by the user by using the web-based application programming interface (API) 300. This is considered a first possible path or process that can be taken to store the input data 102A in the blockchain 112.

In another embodiment, using the web-based application programming interface (API) 300, a first ZKP smart contract 302 can be created, at a front-end. The term “front-end” denotes the part of a computer system or application with which the user or the first classical computer 102 interacts directly. On the other hand, the term “back-end” is the part of a computer system that provides a service to the front-end such as the action of running the first ZKP smart contract 302.

In this embodiment, the first ZKP smart contract 302 can be configured to automatically create a second ZKP smart contract 303 that would in turn generate and store the input data 102A (e.g., quantum computer program). The input data 102A (e.g., quantum computer program) can then be uploaded into or sent to a server or one of the nodes 202 in the plurality of nodes 200. In this configuration, the first ZKP smart contract 302 can be equated to a manufacture of smart contracts that automatically creates a smart contract upon a certain set condition is met, for example upon request by a user. This is considered a second possible path that can be taken to store the input data 102A in the blockchain 112.

For example, this approach can be used when the user is not very familiar with the creation of contracts. In this case, the complex creation of contracts can be handled automatically using the first ZKP smart contract 302. In this approach, an application can be created that would implement a web-based frontend as well as a backend that would be a smart contract. The smart contract would be configured to create the smart contracts discussed above that would store the ZKP of input data (e.g., input data can be a quantum computer program), for example. The input data would then be uploaded into a server and linked to a newly created contract. In this manner the second ZKP contract 303 would verify the existence of the input data and/or some other potential metadata such as the last time the input data was updated or accessed, etc. A login system can also be implemented from the second ZKP contract 303 allowing the user to access the input data. This login system can also be implemented through an application. The use of blockchain technology provides transparency as a user who wants to secure input data can track when new contracts are made and when individuals potentially tried to interact with the contracts to make changes and or attempt to access the input data. Although input data is discussed herein, output data can similarly be processed using the ZKP contract (e.g., the manual ZKP smart contract 301, or the second ZKP smart contract 303 generated by the first ZKP smart contract 302), as described in the above paragraphs.

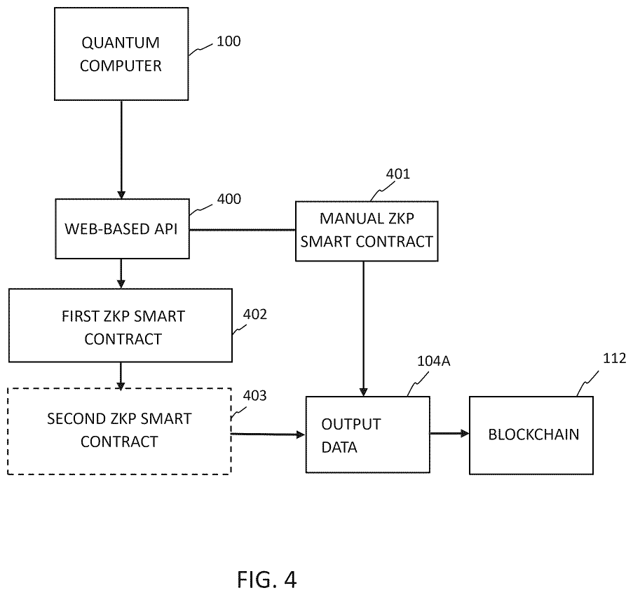

FIG. 4 is a schematic diagram of the quantum computer 100 interacting via a web-based API to generate a zero-knowledge proof (ZKP) smart contract to store the output data 104A in a blockchain 112, according to an embodiment of the present invention. In an embodiment, instead of directly outputting and then storing the output data 104A in the block 112A of the blockchain 112, a web-based application programming interface (API) 400 can be used to generate a zero-knowledge proof (ZKP) smart contract 401 that would then run to store the output data 104A in a block 112A of the blockchain 112 upon receiving the output data 104A from the quantum computer 100. The zero-knowledge proof (ZKP) smart contract 401 can be created manually using the web-based application programming interface (API) 400. The ZKP smart contract 401 can then manually insert the output data 104A into the blockchain 112. The term “manually” is used herein to mean that the web-based API 400 is under the control of a user through a classical computer to control the ZKP smart contract 401.

In another embodiment, the web-based API 400 is directly linked to the quantum computer 100 and is pre-programmed to handle the output data 104A from the quantum computer 100 without any intervention from the user. For example, the web-based application programming interface (API) 400 can be used to create a first zero-knowledge (ZKP) smart contract 402 at a front-end. The first ZKP smart contract 402 can be configured to automatically create a second ZKP smart contract 403 that would in turn store or insert the output data 104A in the blockchain 112. The output data 104A can then be uploaded into a server or one of the nodes 202 in the plurality of nodes 200. The first ZKP contract 402 can be equated to a manufacture of smart contracts that automatically creates the second smart contract 403 upon a certain set condition is met.

In an embodiment, a smart contract can create another smart contract through a process known as “smart contract deployment.” This allows for the creation of a new contract on the blockchain programmatically, based on certain conditions or triggers within existing smart contracts, for example. The mechanism for creating smart contracts from within other smart contracts typically involves a series of steps. The first step is to define the smart contract that is to be created. This includes writing the contract code, specifying its functionality, and setting any initial parameters or conditions.

For example, with respect to the diagram shown in FIG. 3, within an existing first smart contract, for example the first ZKP smart contract 302, logic can be included that triggers the creation of a second contract, for example the second ZKP smart contract 303. This logic often includes one or more conditions that must be met for the second smart contract to be deployed. For example, a user can specify that the second contract is created by the first contract when a certain event occurs, such as a specific date, a certain condition in the data, or the approval of a certain number of participants.

When the one or more conditions specified in the creation logic of the first ZKP smart contract 302 are met, the existing first ZKP smart contract 302 initiates the deployment of the second ZKP smart contract 303. This deployment process typically involves: 1) generating a new smart contract address for the second ZKP smart contract 303 as each smart contract on a blockchain is associated with a unique address, 2) storing the input data 102A created by the second ZKP smart contract 303 on the blockchain 112, 3) setting initial parameters such that if the second ZKP smart contract 303 requires specific parameters or initial values, these parameters are defined at deployment, 4) executing initialization so that after deployment, the second ZKP smart contract 303 can execute any initialization functions or code specified in its constructor such that the input data 102A is added to the blockchain 112, for example.

The specific process for creating smart contracts within other smart contracts can vary depending on the blockchain platform and the programming language used. For example, ETHEREUM smart contracts are created using the SOLIDITY programming language, which includes specific functions for deploying new contracts.

A login system can also be implemented from the web-based smart contract to verify the user's credentials before allowing the user to access the input data 102A (e.g., the quantum computer program). The login system can also be implemented through a standard application. For example, the login system can be implemented using SOLIDITY in the manual ZKP smart contract 301 or the second ZKP smart contract 303.

The use of blockchain 112 improves transparency and security as discussed herein throughout. A user can track when new contracts are made and when users potentially tried to interact with the contracts to make changes and or attempt to access a block containing the input data 102A and/or the output data 104A.

The existing smart contract that triggered the creation can interact with the newly created contract, passing data, making calls, or invoking its functions. This interaction can be part of a larger process or workflow. Smart contracts often use events or notifications to inform external parties about the creation of a new contract. This transparency is used for other participants on the blockchain network to be aware of the new contract's existence and activity. In this manner the zero-knowledge proof smart contract can verify the existence of the input data 102A and/or some other potential metadata like the last time the input data 102A is updated or accessed, etc.

In an embodiment, in each of the procedures of storing or inserting the input data 102A and/or the output data 104A into a block of the blockchain 112, described in the above paragraphs, the blockchain system or the network of plurality of nodes 200 may require a usage fec. The usage fee can be paid by the user using digital currency or cryptocurrency and the record of payment may be recorded in the blockchain 112 and linked to the input data 102A and/or the output data 104A. In another embodiment, the usage fee can be paid for by the owner who controls the web-based API 300 or the web-based API 400. In another embodiment, a controller of system as a whole, may pay the usage fee as an initiative to use the system, for example. In a similar fashion, the usage fee can also be implemented when creating a smart contract, for example, the smart contract 301 or the smart contract 401, that would handle the input data 102A and/or the output data 104A. Similarly, a usage fee can also be implemented when using the first ZKP smart contract 302 to generate the second ZKP smart contract 303 and/or when using the first ZKP smart contract 402 to generated the second ZKP smart contract 403.

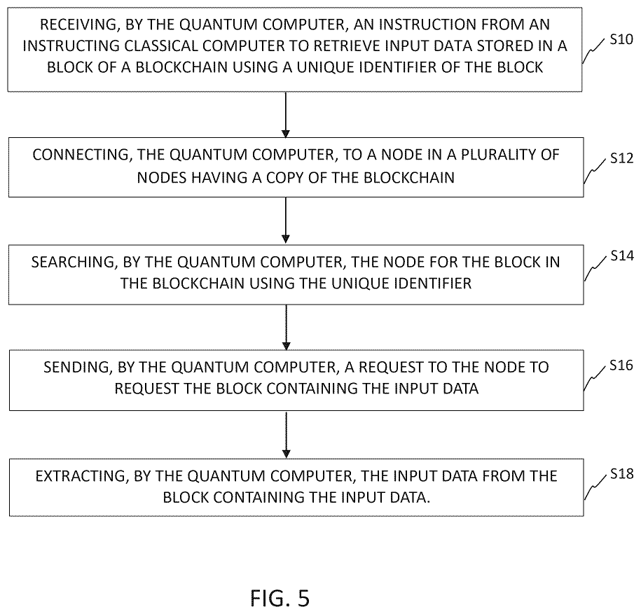

As it must be appreciated in the above paragraphs, an aspect of the present invention is to provide a method of extracting by a quantum computer input data from a blockchain. FIG. 5 is a flowchart of the method of extracting by the quantum computer input data from the blockchain, according to an embodiment of the present invention. The method includes receiving, by the quantum computer, an instruction from an instructing classical computer to retrieve input data stored in a block of a blockchain using a unique identifier of the block, at S10. The method further includes connecting, the quantum computer, to a node in a plurality of nodes having a copy of the blockchain, at S12. The method also includes searching, by the quantum computer, the node for the block in the blockchain using the unique identifier, at S14. The method further includes sending, by the quantum computer, a request to the node to request the block containing the input data, at S16. The method also includes extracting, by the quantum computer, the input data from the block containing the input data, at S18.

In an embodiment, the method includes executing, by the quantum computer, the input data if the input data is a quantum computer program.

In embodiment, the method includes sending, by the quantum computer, to the instructing classical computer a message informing the instructing classical computer that the quantum computer is able to retrieve and read the input data.

In embodiment, the method further includes sending, by the quantum computer, to the instructing classical computer an output data based on the input data.

In embodiment, the method further includes adding or inserting, by the quantum computer, the output data to a block in a blockchain.

In embodiment, the method also includes determining, by the quantum computer, which block in a blockchain to add the output data. In an embodiment, the output data refers to the input data that created the output data such that the block containing the output data refers to the block containing the input data.

Another aspect of the present invention is also to provide a computer readable medium on which is stored non-transitory computer-executable code, which when executed by a quantum computer causes the quantum computer to perform the above method of extracting by the quantum computer input data from a blockchain.

As it must be appreciated from the above paragraphs, an aspect of the present invention is to provide a system for securing input data to a quantum computer or securing output data from the quantum computer, or both. The system includes a quantum computer; a classical computer in communication with the quantum computer, the classical computer being programmed to generate input data and transmit the input data to the quantum computer, or to receive output data by the quantum computer, or both; and a plurality of nodes in communication through the internet, the plurality of nodes being configured to implement a blockchain. The input data or the output data, or both, are added as one or more blocks to the blockchain for secure storage of the input data prior to inputting into the quantum computer, or for secure storage of the output data after outputting by the quantum computer, or the input data or the output data, or both, are securely stored in a storage device and an address associated with a location in the storage device where the input data or the output data, or both are stored is added as one or more blocks to the blockchain.

In an embodiment, each node in the plurality of nodes is associated with a classical server computer.

In an embodiment, the classical computer includes a first classical computer in communication with the quantum computer, the first classical computer being programmed to generate input data and transmit the input data to the quantum computer; and a second classical computer in communication with the quantum computer, the second classical computer being programmed to receive output data from the quantum computer.

In an embodiment, the first classical computer and the second classical computer are a single and same classical computer. In an embodiment, the first classical computer and the second classical computer are in communication with each other through the internet.

In an embodiment, the input data is a quantum computer program generated using a Software Development Kit (SDK) and the output data is a result of a computation of the quantum computer program by the quantum computer. In an embodiment, SDK is selected from the group consisting of: QISKIT, FOREST, PERCEVAL, QUANDELA, OCEAN, PROJECTQ, QIBO, T|KET>, STRAWBERRY FIELDS, PENNYLANE, QUANTUM DEVELOPMENT KIT, and CIRQ.

In an embodiment, the quantum computer is selected from the group consisting of: a superconducting quantum computer, a trapped-ion quantum computer, a photonic quantum computer, a neutral atom quantum computer, a quantum dot quantum computer, and a simulated quantum computer.

Another aspect of the present invention is to provide a system for storing a quantum computer input data or a quantum computer output data, or both in a blockchain. The system includes a network of a plurality of nodes, each node in the plurality of nodes being configured to store a copy of a plurality of blockchains, a first blockchain in the plurality of blockchains having a first plurality of blocks and a second blockchain in the plurality of blockchains having a second plurality of blocks, a block in the first plurality of blocks includes a quantum computer input data; and a quantum computer in communication with the network of the plurality of nodes, the quantum computer being configured to receive or retrieve the quantum computer input data contained in the block of the first plurality of blocks of the first blockchain from the network of the plurality of nodes and to output the quantum computer output data to the network of the plurality of nodes and to store the quantum computer output data in a block of the second plurality of blocks of the second blockchain within the network of the plurality of nodes.

In an embodiment, the first blockchain is the same as the second blockchain such that the quantum computer output data and the quantum computer input data are stored in the same blockchain.

In an embodiment, the quantum computer input is a quantum computer program and the quantum computer output is a result of a quantum computation of the quantum computer program.

In an embodiment, the quantum computer input data is an input parameter of a quantum computer program.

In an embodiment, the quantum computer is selected from the group consisting of: a superconducting quantum computer, a trapped-ion quantum computer, a photonic quantum computer, a neutral atom quantum computer, a quantum dot quantum computer, and a simulated quantum computer.

In an embodiment, the plurality of blockchains are stored in cloud-based storage devices or local premises storage systems, or both.

In an embodiment, the plurality of blockchains are generated using a platform selected from the group consisting of: ETHEREUM, BITCOIN, BINANCE SMART CHAIN, CARDANO, POLKADOT, SOLANA, TEZOS, RIPPLE, CHAINLINK, STELLAR, EOS, AVALANCE, and FILECOIN.

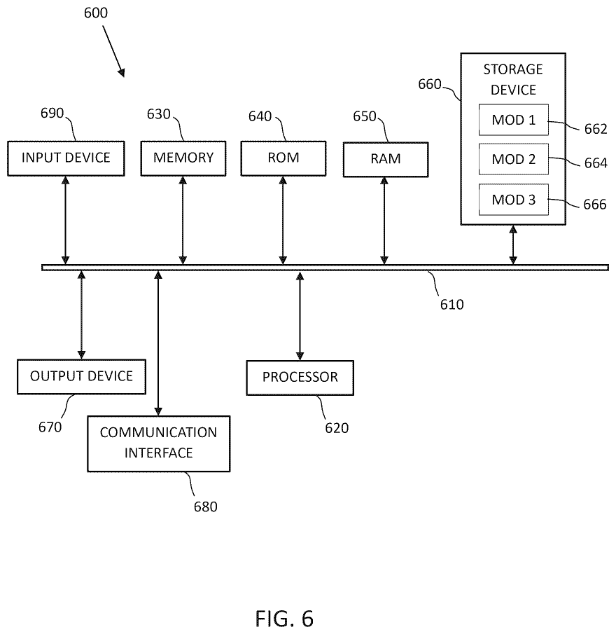

FIG. 6 is a diagram of a general computer system 600 used to interact with the quantum computer 100, according to an embodiment of the present invention. The general computer system can be used, for example, as the first classical computer 102, the second classical computer 104, and/or the instructing classical computer 210. With reference to FIG. 6, the computer system 600 includes a general-purpose computing device including a processing unit 620 and a system bus 610 that couples various system components including the system memory 630 such as read-only memory (ROM) 640 and random-access memory (RAM) 650 to the processor 620. The processing unit 620 can be a computer processing unit (CPU), a graphical processing unit (GPU), or a digital signal processor (DSP). The processing unit 620 can have one or more processing cores. The computer system 600 can include a cache of high-speed memory connected directly with, in close proximity to, or integrated as part of the processor 620. The computer system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the computer device 600 can also have more than one processor 620 or on a group or cluster of computing devices networked together to provide greater processing capability. The processor 620 can include any general-purpose processor and a hardware module or software module, such as module 662, module 664, and module 666 stored in storage device 660, configured to control the processor 620 as well as a special-purpose processor where software instructions are incorporated into the actual processor design. The processor 620 may essentially be a completely self-contained computer system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computer system 600 further includes storage devices 660 such as a hard disk drive, a magnetic disk drive, an optical disk drive, tape drive or the like. The storage device 600 can also include network attached storage (NAS). The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. The communication interface 680 may also include wired or wireless modems for communicating with the internet. There is no restriction on operating on any particular hardware arrangement and therefore the basic features here may easily be substituted for improved hardware or firmware arrangements as they are developed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. For example, features in one embodiment can be combined with features of a different embodiment. The terminology used herein was chosen to best explain the principles of the embodiments, the practical application or technical improvement over technologies found in the marketplace, or to enable others of ordinary skill in the art to understand the embodiments disclosed herein.

I claim:

1. A system for storing a quantum computer input data or a quantum computer output data, or both in a blockchain, the system comprising:
a network of a plurality of nodes, each node in the plurality of nodes being configured to store a copy of a plurality of blockchains, a first blockchain in the plurality of blockchains having a first plurality of blocks and a second blockchain in the plurality of blockchains having a second plurality of blocks, a block in the first plurality of blocks includes a quantum computer input data; and
a quantum computer in communication with the network of the plurality of nodes, the quantum computer being configured to receive or retrieve the quantum computer input data contained in the block of the first plurality of blocks of the first blockchain from the network of the plurality of nodes and to output the quantum computer output data to the network of the plurality of nodes and to store the quantum computer output data in a block of the second plurality of blocks of the second blockchain within the network of the plurality of nodes.

2. The system according to claim 1, wherein the first blockchain is the same as the second blockchain such that the quantum computer output data and the quantum computer input data are stored in the same blockchain.

3. The system according to claim 1, wherein the quantum computer input data is a quantum computer program and the quantum computer output data is a result of a quantum computation of the quantum computer program.

4. The system according to claim 1, wherein the quantum computer input data is an input parameter of a quantum computer program.

5. The system according to claim 1, wherein the quantum computer is selected from the group consisting of: a superconducting quantum computer, a trapped-ion quantum computer, a photonic quantum computer, a neutral atom quantum computer, a quantum dot quantum computer, and a simulated quantum computer.

6. The system according to claim 1, wherein the plurality of blockchains are stored in cloud-based storage devices or local premises storage systems, or both.

7. The system according to claim 1, wherein the plurality of blockchains are generated using a platform selected from the group consisting of: ETHEREUM, BITCOIN, BINANCE SMART CHAIN, CARDANO, POLKADOT, SOLANA, TEZOS, RIPPLE, CHAINLINK, STELLAR, EOS, AVALANCE, and FILECOIN.

8. A system for securing input data to a quantum computer or securing output data from the quantum computer, or both, the system comprising:
a quantum computer;
a classical computer in communication with the quantum computer, the classical computer being programmed to generate input data and transmit the input data to the quantum computer, or to receive output data from the quantum computer, or both;
a plurality of nodes in communication with each other through the internet, the plurality of nodes being configured to implement a blockchain;
wherein the input data or the output data, or both, are added as one or more blocks to the blockchain for secure storage of the input data prior to inputting into the quantum computer, or for secure storage of the output data after outputting by the quantum computer, or
wherein the input data or the output data, or both, are securely stored in a storage device and an address associated with a location in a storage device where the input data or the output data, or both are stored is added as one or more blocks to the blockchain.

9. The system according to claim 8, wherein each node in the plurality of nodes is associated with a classical server computer.

10. The system according to claim 8, wherein the classical computer comprises a first classical computer in communication with the quantum computer, the first classical computer being programmed to generate input data and transmit the input data to the quantum computer; and a second classical computer in communication with the quantum computer, the second classical computer being programmed to receive output data from the quantum computer.

11. The system according to claim 10, wherein the first classical computer and the second classical computer are a single and same classical computer.

12. The system according to claim 10, wherein the first classical computer and the second classical computer are in communication with each other through the internet.

13. The system according to claim 8, wherein the input data is a quantum computer program generated using a Software Development Kit (SDK) and the output data is a result of a computation of the quantum computer program by the quantum computer.

14. The system according to claim 13, wherein the SDK is selected from the group consisting of: QISKIT, FOREST, PERCEVAL, QUANDELA, OCEAN, PROJECTQ, QIBO, T|KET>, STRAWBERRY FIELDS, PENNYLANE, QUANTUM DEVELOPMENT KIT, and CIRQ.

15. The system according to claim 8, wherein the quantum computer is selected from the group consisting of: a superconducting quantum computer, a trapped-ion quantum computer, a photonic quantum computer, a neutral atom quantum computer, a quantum dot quantum computer, and a simulated quantum computer.

16. A method of extracting by a quantum computer input data from a blockchain, the method comprising:
receiving, by the quantum computer, an instruction from an instructing classical computer to retrieve input data stored in a block of a blockchain using a unique identifier of the block;
connecting, the quantum computer, to a node in a plurality of nodes having a copy of the blockchain;
searching, by the quantum computer, the node for the block in the blockchain using the unique identifier;
sending, by the quantum computer, a request to the node to request the block containing the input data; and
extracting, by the quantum computer, the input data from the block containing the input data.

17. The method according to claim 16, further comprising executing, by the quantum computer, the input data if the input data is a quantum computer program.

18. The method according to claim 16, further comprising sending, by the quantum computer, to the instructing classical computer a message informing the instructing computer that the quantum computer is able to retrieve and read the input data.

19. The method according to claim 16, further comprising sending, by the quantum computer, to the instructing classical computer an output data based on the input data.

20. The method according to claim 19, further comprising adding, by the quantum computer, the output data to a block in a blockchain.
